(19) United States
(12) Patent Application Publication
(10) Pub. No.: US 2012/0266191 A1
(43) Pub. Date: Oct. 18, 2012

(54) SYSTEM AND METHOD TO PROVIDE MESSAGES ADAPTIVE TO A CROWD PROFILE

(75) Inventors: Magnus Abrahamsson, Lund (SE); Kåre Agardh, Lund (SE); Gunnar Klinghult, Lund (SE); Magnus Midholt, Lund (SE); Claes Nilsson, Lund (SE); Magnus Persson, Lund (SE); Heino Wendelrup, Lund (SE)

(73) Assignee: SONY ERICSSON MOBILE COMMUNICATIONS AB (A company of Sweden), Lund (SE)

(21) Appl. No.: 13/257,468

(22) PCT Filed: Feb. 10, 2011
(86) PCT No.: PCT/IB2011/000245

§ 371 Date: Sep. 19, 2011

Related U.S. Application Data
(60) Provisional application No. 61/424,135, filed on Dec. 17, 2010.

(51) Int. Cl. G06Q 30/02; H04N 21/2668

(52) U.S. Cl. 725/35; 705/14.49; 705/14.58

(57) ABSTRACT

A method and system that makes use of social networking data and/or sensor data gathered from personal mobile radio terminal-based sensors (36-48) and/or advertisement display (14) based sensors to select and to serve relevant messages to render to a group of individuals. The messages are chosen to maximize the impact the messages will have on the target audience based on the likes/dislikes of the crowd, any mood the individuals may be experiencing, or any other relevant data.

### TECHNICAL FIELD OF THE INVENTION

The present invention relates generally to serving messages and, more particularly, to serving messages that are tailored to a crowd profile based on aggregate interest information derived from sensor data and/or social network information associated with individuals that compose the crowd.

### BACKGROUND

Advertising using traditional media, such as television, radio, newspapers and magazines, is well known. Advertisers have used these types of media to reach a large audience with their advertisements (“ads”). To reach a more responsive audience, advertisers have turned to targeted advertising.

Targeted advertising is a type of advertising whereby ads are placed so as to reach consumers based on various traits of the consumers such as demographics, purchase history, or observed behavior. Two principal forms of targeted advertising are behavioral targeting and contextual advertising.

Behavioral targeting allows website owners or ad networks to display content more relevant to the interests of an individual user viewing a webpage by using information collected on the user's web-browsing behavior, such as the pages the user has visited or the searches the user has made, to select which advertisements to display to that user. Most platforms identify users by assigning a unique identification cookie to each and every user to the site, thereby allowing the user to be tracked throughout their web journey.

Behavioral targeting systems utilize at least one of two decision-making methods to determine what advertisements to display. In one method, self-learning onsite behavioral targeting systems monitor visitor response to site content and learn what is most likely to generate a desired conversion event. A conversion event occurs when a target takes the marketer's intended action. If the target has visited a marketer's web site, the conversion action might be making an online purchase, submitting a form to request additional information, and the like. A conversion rate is the percentage of visitors who take the conversion action. In the second method, providers use a rules-based approach, allowing administrators to set the content and advertisements shown to those users with particular traits.

Contextual advertising is a form of targeted advertising for advertisements appearing on websites or other media, such as content displayed in mobile browsers. The advertisements themselves are selected and served to the display media by automated systems based on the content displayed to the user. A typical contextual advertising system scans the text of a website for keywords and outputs advertisements to the webpage based on what a user is viewing. The advertisements are typically displayed on the webpage or as pop-up ads. For example, if a user is viewing a website pertaining to literature and that website uses contextual advertising, the user may see advertisements for literature-related companies, such as used book-sellers, colleges offering English degrees, and the like. Contextual advertising is also used by search engines to display advertisements on their search results pages based on the keywords in the user's query. Contextual advertising is also utilized in television commercials to target advertisements based on the demographics of the expected audience.

### SUMMARY

One problem with conventional targeted advertising is that there is no mechanism to dynamically adjust a mass advertisement/message in real time based on the profile of individuals of which a crowd is composed. The present invention overcomes this problem by using information acquired from sensor networks and/or social media networks to dynamically adjust messages in real time based on the composition of the crowd.

According to one aspect of the invention, a method of providing messages includes receiving information related to advertisement targets, processing the information to determine aggregate interest information, wherein the aggregate interest information corresponds to one or more interests of the advertisement targets, selecting at least one message based on the aggregate interest information, and outputting the at least one selected message to an advertisement consumer for rendering by one or more of the advertisement targets.

According to another aspect, the advertisement targets are verified to be within a geographic area.

According to another aspect, the advertisement targets are predicted to pass an advertisement consumer.

According to another aspect, the step of outputting at least one selected message includes selecting a message from a database of messages provided by at least one advertiser.

According to another aspect, the method further includes billing at least one advertiser corresponding to the selected message based on a number of advertisement targets interested in the advertisement, a number of advertisement targets within sensory range of the message, a location of the advertisement consumer, or a time of day in which the selected message is output.

According to another aspect, selecting the at least one message includes generating a new message based on the aggregate interest information.

According to another aspect, the at least one message includes a non-commercial mood-altering display.

According to another aspect, at least some of the information related to advertisement targets is obtained from social-networking data.

According to another aspect, the at least one message includes an advertisement.

According to another aspect of the invention, an advertisement consumer system includes at least one dynamic media device and a communications device connected to an advertisement processor. The communications device is configured to receive messages from the advertisement processor, the at least one dynamic media device is configured to present the messages, and the messages are selected based on aggregate interest information of advertisement targets within sensory range of the dynamic media device.

According to another aspect, the advertisement consumer system includes sensors configured to provide information to an advertisement processor.

According to another aspect, the at least one dynamic media device includes a speaker.

According to another aspect, the at least one dynamic media device includes an electronic billboard.

According to another aspect, the at least one dynamic media device includes a general purpose computer and monitor.

According to another aspect, the at least one dynamic media device includes a television.

According to another aspect, the aggregate interest information is at least partly derived from social-networking data.

According to another aspect, the aggregate interest information is at least partly derived from sensor data.

According to another aspect of the invention, a method of identifying advertisement targets includes receiving a location of an advertisement consumer and a time, receiving at least one of location information or travel information of a plurality of individuals, determining respective likelihoods of the plurality of individuals being within sensory range of the advertisement consumer at the time, and selecting at least one individual from the plurality of individuals to be one of the advertisement targets.

According another aspect, the location information and travel information is derived from at least one of Global Positioning System information, cellular tower connection information, wireless access point connection information, or social-networking information.

According to another aspect, the method includes processing network sensor information to determine a reaction from at least one of the plurality of individuals to a message appearing on the advertisement consumer.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram illustrating an exemplary environment within which the invention may be implemented in accordance with aspects of the present invention.

FIG. 2 is a diagram illustrating an exemplary apparatus in accordance with aspects of the present invention.

FIG. 3 is a diagram illustrating an exemplary advertisement consumer in accordance with aspects of the present invention.

FIG. 4 is a diagram functionally illustrating an exemplary advertisement processor in accordance with aspects of the present invention.

FIG. 5 is a flow diagram of an exemplary method of producing target interest information in accordance with aspects of the present invention.

FIG. 6 is a flow diagram of an exemplary method of providing relevant advertisements in accordance with aspects of the present invention.

FIG. 7 is a flow diagram of an exemplary method of identifying advertisement targets in accordance with aspects of the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, e.g., electronic organizers, personal digital assistants (PDAs), smartphones, portable communication devices and the like.

The messages stored, selected, rendered, displayed, output, or otherwise used by or with various embodiments of the present invention may be any type of message including, for example, political advertisements, commercial advertisements, government warnings, behavioral suggestions, mood-altering displays, and so on. Although further descriptions use the term “advertisement” or “advertising,” it should be understood that all types of messages are contemplated as being included within the present invention, and that the terms “advertisement” and “advertising” should be interpreted broadly, and are not meant to be limiting.

The present invention makes use of social networking data and/or sensor data gathered from personal mobile radio terminal-based sensors and/or advertisement display based sensors to select and to serve relevant messages to dynamic media devices that render (e.g., display on a video screen) the messages to groups of individuals (also referred to herein as a “crowd”). When the messages are in the form of advertisements, the messages are chosen to appeal to a majority of individuals that compose the crowd, to strongly correlate with the interests of one or more individuals in the crowd, or some combination thereof that strongly correlates with the aggregate interests of the group. In this manner, the impact the advertisements have on the target audience based on the likes/dislikes of the crowd, any mood the individuals may be experiencing, or any other relevant data will be maximized. These factors and the like—e.g. that information that is relevant in determining the expected success or impact of the advertisement from a marketing perspective—are referred to, herein, as aggregate interest information.

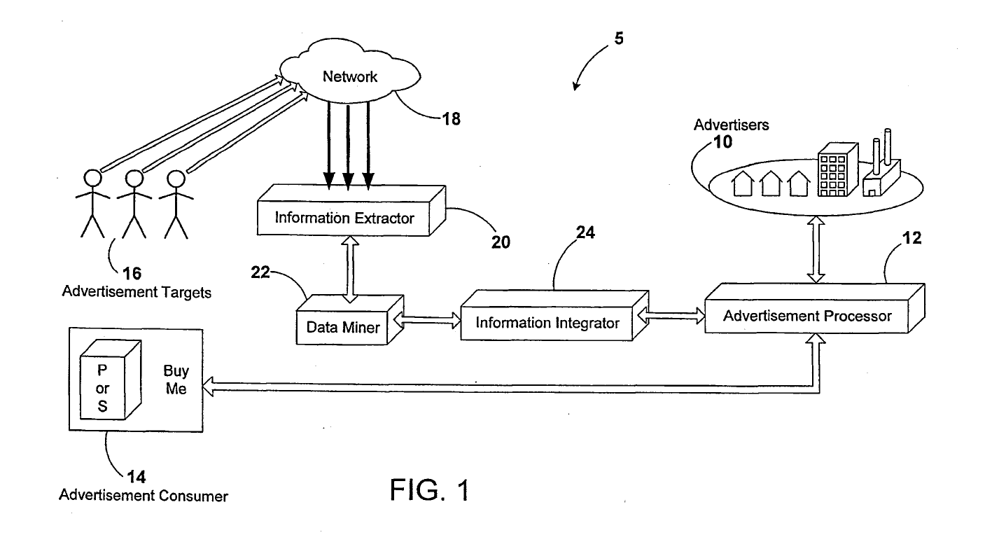

FIG. 1 is a diagram illustrating an exemplary environment 5 within which the invention may be implemented. The environment includes one or more advertisers 10, an advertisement processor 12, an advertisement consumer 14, advertisement targets 16, a network 18, an information extractor 20, a data miner 22, and an information aggregator 24.

The advertisers 10 may be one or more parties that directly sell the goods or services being advertised (e.g., Sony Ericsson Mobile Communications AB; Sears, Roebuck and Co.; Saab Automobile AB; Ford Motor Company; etc.) or an agent authorized to act on the advertiser's behalf. One of ordinary skill in the art will appreciate that the advertisement desired to be displayed by an advertiser may exist in a variety of forms ranging from standard print advertisements, online advertisements, video advertisements, audio advertisements, audio/visual advertisements, or any other type of sensory message.

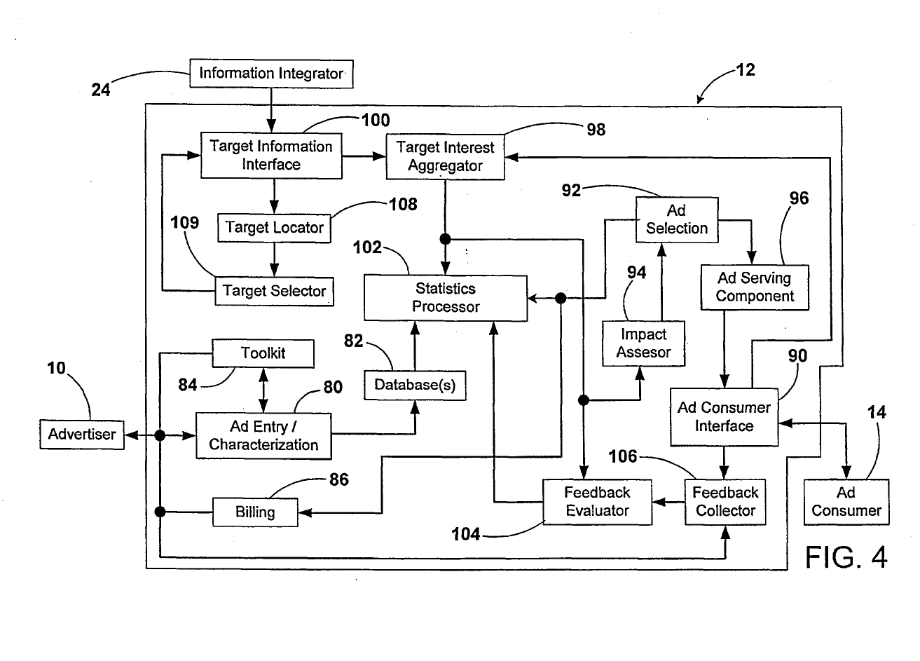

Advertisement processor 12 interfaces with the one or more advertisers 10, the information extractor 24, and the advertisement consumer 14. The advertisement processor 12 may perform a variety of functions, as explained in more detail below in reference to FIG. 4.

Advertisement consumer 14 is an entity that may issue a request for advertisements to the advertisement processor 12, obtain the advertisements from the advertisement processor 12, and present the advertisement to the advertisement targets 16. Non-exhaustive examples of an advertisement consumer 14 in accordance with aspects of the present invention are electronic billboards, movie theaters, stores with speaker systems, television content providers, and internet-based video players, for example.

Advertisement targets 16 are the set of individuals who ultimately perceive the advertisement displayed or otherwise rendered from the advertisement consumer 14. In the case of visual advertisements, for example, the advertisement targets 16 are the people who view, or are at least predicted to view, the advertisement. In some cases, advertisement targets 16 may be non-human entities that make purchasing decisions or suggestions (e.g., a car configured to remind a human to get gasoline receiving a wireless advertisement from a gas station).

Network 18 is one or more servers and other communications devices making up the World Wide Web and other data and communications networks accessible to advertisement targets 16. The network 18 includes third party portals that may be used for social networking and the like (e.g., Facebook, Myspace, etc.). As described more fully below, advertisement targets 16 create, consume, transfer and otherwise interact with information on and through the network 18.

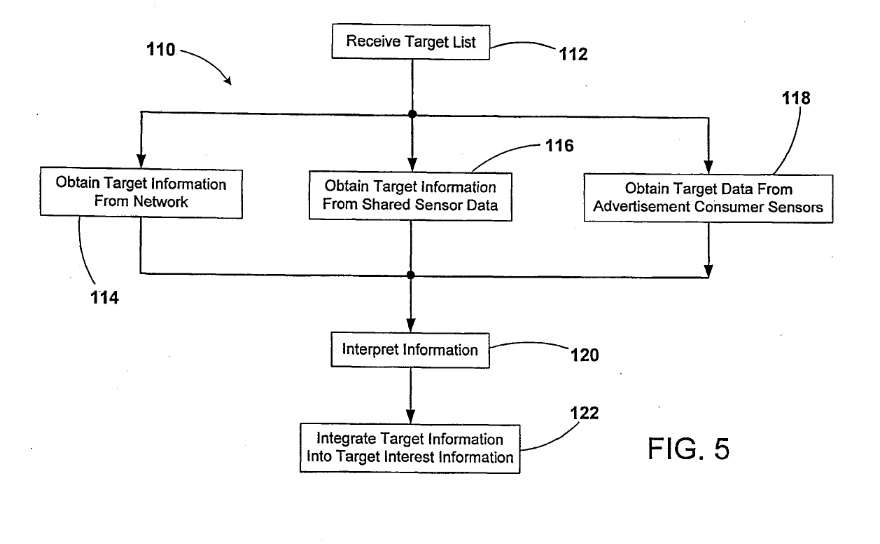

Information extractor 20 may extract data from network 18 related to individual advertisement targets 16 and interpret this data into information that is understandable to machines such that logical operations are able to be performed using this information. Further details of the operation of information extractor 20 are provided below in reference to FIG. 5.

Data miner 22 may use information regarding the individual advertisement targets 16 to extract patterns and/or to interpret the available information at a higher conceptual level. Further details of the operation of data miner 22 are provided below in reference to FIG. 5.

Information integrator 24 may combine information from sources including but not limited to information derived from the network 18 to create up-to-date integrated information profiles of individual advertisement targets 16. Further details of the operation of information integrator 24 are provided below in reference to FIG. 5.

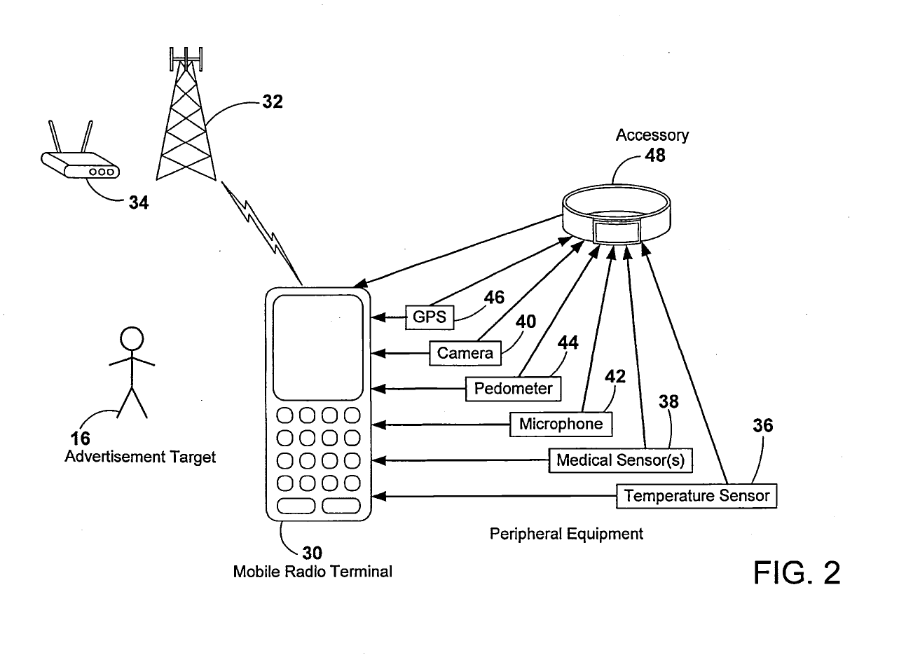

FIG. 2 is a diagram illustrating an apparatus 30 with which at least portions of the invention may be implemented. The apparatus may be any type of mobile radio terminal 30 used by an advertisement target 16. The mobile radio terminal 30 may be used to access the network 18. Such access may be in the form of telephone calls through a cell tower 32 or accessing the Internet or other data services through a cell tower 32 or wireless access point 34.

The mobile radio terminal 30 may be outfitted with peripheral equipment such as a temperature sensor 36, medical sensor(s) (that measure(s), e.g., heart rate, blood pressure, blood oxygenation, skin conductivity, blood sugar, etc.) 38, camera 40, microphone 42, pedometer 44, and/or Global Positioning System (GPS) unit 46 to collect information about the advertisement target 16 or their surroundings (including other advertisement targets 16). Such peripheral equipment may be housed within the mobile radio terminal 30 and/or coupled externally from the mobile radio terminal through a port and/or a wireless interface (e.g., Bluetooth, infrared, near field communication, etc.). In one embodiment, these and other sensors may be located in at least one accessory 48 to a mobile phone that may be worn on the body or clothing of a user (e.g. headsets, bracelets, watches, and so on) and is capable of communicating with the mobile phone to store, track, transfer and/or analyze collected data, for example.

Information collected by these sensors in communication with the mobile radio terminal 30 may, for example, be reaction information from one or more advertisement targets 16. Reaction information may be used, for example, to dynamically enhance the profiling of an advertisement target 16 or an advertisement rendered to an advertisement target 16. Reaction information may also be used, for example, to determine when or how much to bill an advertiser 10 (e.g., a more emotional reaction may indicate a higher likelihood of conversion, and therefore indicate that an increased billing rate is appropriate). These example uses for reaction information should not be considered limiting, as other uses will be apparent to those of ordinary skill in the art upon reading and understanding this disclosure. Further, information other than reaction information may be collected by these sensors as described below in reference to FIG. 5.

Mobile radio terminal 30 may also communicate directly or indirectly with an advertisement consumer 14, advertisement processor 12, information integrator 24, data miner 22 and/or information extractor 20 by periodically transmitting information to such entities. For example, the mobile radio terminal 30 may include one or more applications that are configured to transmit data associated with the user to the network 18, which may share the user data to the advertisement consumer 14, advertisement processor 12, information integrator 24, data miner 22 and/or information extractor 20.

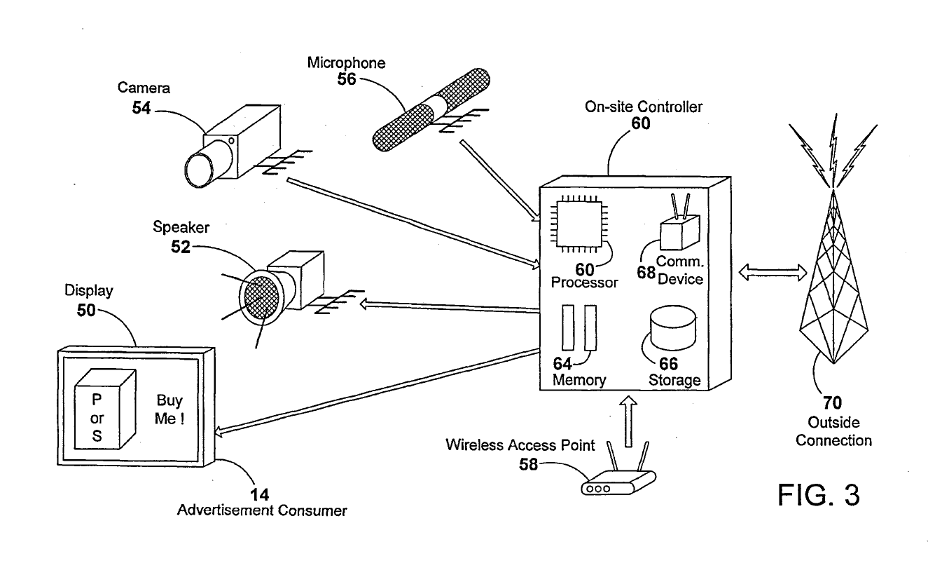

FIG. 3 is a diagram illustrating an advertisement consumer 14. The advertisement consumer 14 may include static and/or dynamic media devices such as a visual display 50 and/or speaker 52. Dynamic media devices may include, for example, a television, a general purpose computer, a liquid crystal monitor, and an electronic billboard, a speaker system, and so on. The advertisement consumer 14 may include any media device or combination of devices capable of outputting sensory data to the advertisement targets 16.

The advertisement consumer may also include sensors to receive information about the surroundings of the advertisement consumer 14. Such sensors may include, without limitation, a camera 54 and a microphone 56. Information collected by these sensors may, for example, be reaction information from one or more advertisement targets 16. Reaction information may be used, for example, as described above in relation to FIG. 2. Further, information other than reaction information may be collected by these sensors as described below in reference to FIG. 5.

The advertisement consumer 14 may also include an integrated wireless access point 58 (which may or may not be the wireless access point 34 illustrated in FIG. 2). The wireless access point 58 may provide for an expedient method of identifying and collecting current data regarding advertisement targets 16. The advertisement consumer 14 may be controlled by an on-site (i.e. physically located at or near the advertisement consumer 14) or integrated controller 60 which may include a processor 62, a memory 64, a storage device 66, and a communications device 68, for example. The communications device 68 may communicate with outside devices (such as the advertisement processor 12, for example) through an outside connection 70 that may be wireless or hard-wired. The advertisement processor 12 may be integrated with the advertisement consumer 14 or it may be a separate device.

FIG. 4 is a diagram functionally illustrating an advertisement processor 12 in accordance with aspects of the present invention. The advertisement processor 12 may include, for example, a microprocessor, data storage component, memory module, and communications device (e.g. a modem). The advertisement processor 12 may be, for instance, a general purpose computer or server. Functionally, the system includes an advertisement entry and characterization component 80, one or more databases 82, a toolkit component 84, a billing component 86, an advertisement consumer interface component 90, an advertisement selection component 92, an impact assessor 94, an advertisement serving component 96, a target interest aggregator 98, a target information interface 100, a statistics processor 102, a feedback evaluator 104, a feedback collector 106, a target locator 108, and a target selector 109. To help further understand the invention, the components of an advertising system will be explained below. Furthermore, although FIG. 4 shows a particular arrangement of components constituting advertisement processor 12, one of ordinary skill in the art will recognize that not all components need be arranged as shown, not all components are required, and that other components may be added to, or replace, those shown.

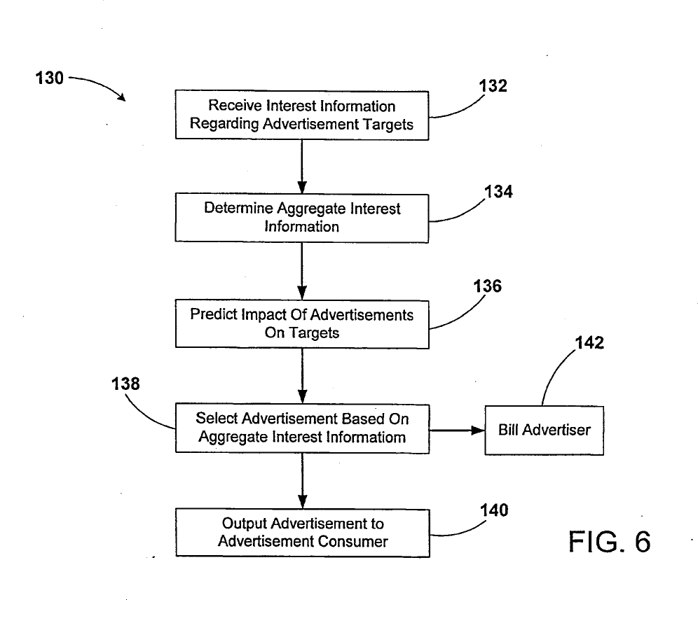

Advertisement entry and characterization component 80 is a component by which an advertiser 10 enters information required for an advertising campaign and manages the campaign. An advertisement campaign contains one or more advertisements that are related in some manner. For example, the retailer Sears, Roebuck and Co. may have an advertisement campaign for Craftsman® tools, which could contain a series of advertisements related to that topic. Among the other things that could be provided by an advertiser 10 through advertisement entry and management component 80 are the following: one or more sets of keywords or topics associated with the advertisements (which may be used as targeting information for the advertisements), geographic targeting information, a value indication for the advertisement, start date, end date, etc. The data required for, or obtained by, advertisement entry and characterization component 80 may reside in one of the databases 82. Whether or not advertiser 10 provides targeting information about an advertisement, advertisement entry and characterization component 80 may provide an automated analysis or characterization of the advertisement that supplements or replaces any targeting information provided by advertiser 10. Such automated analysis can be performed using any method known to a person of ordinary skill in the art, and, for example, may be combined with the advertisement selection process (discussed further in relation to FIG. 6) using a recommendation system, as described below.

Database(s) 82 may contain a variety of data used by advertisement processor 12. In addition to the information mentioned above in reference to advertisement entry and characterization system 80, databases 82 may contain, for example, statistical information about what advertisements have been shown, how often they have been shown, the number of times they have been selected, who has viewed (or been predicted by advertisement processor 12 to have viewed) those advertisements, how often display of the advertisements has led to a conversion (e.g., a subsequent purchase of the advertised product), and so on. Although the databases 82 are shown in FIG. 4 as one unit, a person of ordinary skill in the art will recognize that multiple databases may be employed for gathering and storing information used in advertisement processor 12 and the databases may be stored in one or more servers.

Toolkit component 84 may contain a variety of tools designed to help the advertiser 10 create, monitor, and manage its advertising campaigns (e.g., for goods, services, political office, and so on). For example, toolkit component 84 may contain a tool for helping advertiser 10 estimate the number of selections or renderings an advertisement will receive for a particular keyword or topic. Similarly, toolkit component 84 may be used to help advertiser 10 generate a list of keywords or topics for a given advertisement, or to generate additional keywords or topics based on ones already supplied by advertiser 10. Other possible tools may be provided as well. Depending on the nature of the tool, one or more databases 82 may be used to gather or to store information.

Billing component 86 may perform billing-related functions. For example, billing component 86 may generate invoices for a particular advertiser 10. In addition, billing component 86 may be used by advertiser 10 to monitor the amount being expended for its various advertisements. The data required for, or obtained by, billing component 86 may reside in a database 82.

Advertisement consumer interface 90 may interface with advertisement consumer 14 to obtain or to send information. For example, advertisement consumer 14 may send a request for one or more advertisements to advertisement consumer interface 90. The request may include information such as the site identifier and location requesting the advertisement, any sensor information collected by the advertisement consumer 14, the number of ads requested, etc. In response, advertisement consumer interface 90 may provide one or more advertisements to advertisement consumer 14. In addition, advertisement consumer 14 may send sensor data collected during and after the presentation of the advertisement back to the advertisement processor via the ad consumer interface 90. This data may be useful in gauging the reaction of advertisement targets 16 to the presented advertisement. Alternatively, advertisements may be provided without request, for example on a predetermined schedule.

Advertisement selection component 92 may receive a request for a specified number of advertisements, coupled with information from the impact assessor component 94 to help select the appropriate advertisements. Advertisement selection component 92 may select the advertisement(s) that maximize the expected impact on the group of advertisement targets based on aggregate interest information. Details of this selection process are provided more fully below, in relation to FIG. 6.

Advertisement serving component 96 may receive an advertisement selection from advertisement selection component 92, and format that advertisement into a manner suitable for presenting to advertisement consumer 14. This process may involve, for example, rendering the advertisements into hypertext markup language (HTML), into a proprietary data format, etc.

Impact assessor component 94 may receive aggregate interest information from the target interest aggregator 98 and access advertisement information from a database 82. Impact assessor component 94 may use this information to predict how much impact a particular advertisement will have on the group of advertisement targets 16 using any appropriate method. Examples of such methods and further details of this process are discussed in relation to FIG. 6.

Target interest aggregator 98 may receive interest information regarding individual advertisement targets 16 from information integrator 24 through target information interface 100 and combine this interest information into aggregate interest information. This interest information may be combined in numerous ways. As an example, if the interest information received is formatted such that certain product types receive weights depending on the interest level of a particular advertisement target 16, then these weights may simply be summed across the group of advertisement targets 16. In addition to or alternatively, the interest information of certain advertisement targets 16 may be given unequal weight based on a variety of factors including propensity to purchase, wealth, size of social network, probability of being within range of advertisement consumer 14, etc. Many more complex mechanisms are also known to those of ordinary skill in the art, but will be omitted for brevity.

Target information interface 100 may send and receive data from information integrator 24. Non-exhaustive examples of received data may include interest information and location information. Non-exhaustive examples of sent data may include lists of advertisement targets 16. Alternatively, lists of advertisement targets 16 may be sent directly to information extractor 20.

Statistics processor 102 may contain information pertaining to the selection and performance of advertisements. For example, statistics processor 102 may log the information provided by advertisement consumer 14 as part of an advertisement request, the advertisements selected for that request by advertisement selection component 92, and the presentation of the advertisements by advertisement serving component 96. In addition, statistics processor 102 may log information from the feedback evaluator 104 about the success of the advertisement once it has been provided to advertisement consumer 14.

Feedback evaluator 104 may receive information from the feedback collector 106 regarding the success of an advertisement and evaluate the feedback based on, for example, the location information, reaction information, interest information, and the aggregate interest information of the advertisement targets 16 that the advertisement was presented to. This information may be used to optimize the processes used throughout the advertisement processor 12.

Feedback collector 106 may receive reaction information from the advertisement consumer interface 90 regarding sensor perceptions of the advertisement consumer 14. These sensor perceptions may contain information regarding the reaction of advertisement targets 16 to the presented advertisement. Although not shown in FIG. 4, the feedback collector 106 may also receive information from the sensors in communication with the mobile radio terminal 30. This reaction information may be obtained, for example, by the wireless access point 58 of the advertisement consumer 14 (in communication with the mobile radio terminal 30), or may be accessed on the network 18 at a later time by, for example, information extractor 20. This reaction information from the mobile radio terminal 30 may provide strong insight into the physical reactions of an advertisement target 16. For example, camera data may be processed using facial detection and computer vision techniques to determine probable emotions (e.g., detecting smiles) and user reaction to an advertisement. Finally, the feedback collector 106 may receive data from the advertiser 10 regarding conversion events. This information may be inferred based upon probable perception of a displayed advertisement, may be obtained through questionnaires, and/or even obtained through data obtained from network 18.

Target locator 108 may receive individual location data from the target information interface 100. Target locator 108 may use this information to determine the approximate location of an individual. The approximate location may be a present or a future location. The location information may be expressed in any desirable format. For example, the location information may be expressed as latitude and longitude coordinates, in relative terms, and/or may be expressed as a probability distribution.

Target selector 109 may select specific individuals and/or groups of individuals to be advertisement targets 16 based on their probable locations.

FIG. 5 is a flow diagram of an exemplary method 110 of producing target interest information for selecting advertisements that are likely to have broad appeal to a majority of individuals in a crowd. The method 110 may be executed at one or more servers that support the functionality of the information extractor, the data miner 22, information integrator 24, and/or advertisement processor 12, for example.

At block 112, a list of advertisement targets 16 is received at the information extractor 20. The list is based on identification of individuals within a geographic region who are able to perceive one or more advertisement consumer 14. One of ordinary skill in the art will recognize that an identification of advertisement target 16 may occur in a separate component and/or in a component that performs multiple functions.

At block 114, target information is extracted from the network 18. As set forth below, target information may include any and all information available through network sensors and/or social networking websites.

Social translucence, or the propensity to make more of our lives public through social networking, may provide the foundation of raw data for making this form of target information useful for targeted advertising. A target's entire digital footprint might be used in targeted advertising. A digital footprint is the collection of activities and behaviors recorded when a person interacts in a digital environment. Inputs to a digital footprint include viewed pages, physical location, time of day, search results and key words, content created and consumed, digital activity and data from sensors, and similar information from the user's social network or crowd. Illustrative examples of some useful data from a digital footprint that can be obtained through block 114 include keyword searches, rankings of products on Amazon.com (or other shopping portal), purchase records at various online storefronts, contents of registries and wishlists, ratings of movies on Netflix.com (or other streaming portal), blog entries, Twitter posts and Facebook (or other social media) status updates, Facebook (or other social media) profile information, multimedia content viewed online (e.g., at YouTube, Hulu, etc.), and records of items viewed in online stores, for example. Many of these data can be found in lifestreaming applications used to aggregate user's online actions into one virtual location. Such aggregators (e.g., Posterus, Sweetcron, Collectedin, Flavors.me, Tumblr, etc.) may make the process of obtaining information about advertisement targets 16 easier in many instances.

At block 114, the information extractor 20 may use various information extraction techniques known in the art to gather information related to advertisement targets 16. Some exemplary subtasks that may—but need not—be performed by information extractor 20 are, for example:
Named Entity Recognition: recognition of entity names (for people and organizations), place names, temporal expressions, and certain types of numerical expressions.
Coreference resolution: detection of coreference and anaphoric links between text entities. In information extraction tasks, this is typically restricted to finding links between previously-extracted named entities. For example, “Ford” and “Ford Motor Company” refer to the same real-world entity.
Terminology extraction: finding the relevant terms for a given corpus.
Relationship Extraction: identification of relations between entities, such as:
   PERSON works for ORGANIZATION (extracted from the sentence “Fred works for Ford.”)
   PERSON located in LOCATION (extracted from the sentence “Fred is in Detroit.”).

The growth of the Semantic Web may allow information extractor 20 to more easily understand the meaning of information on the World Wide Web. While the term “Semantic Web” is not formally defined it is mainly used to describe the model and technologies proposed by the World Wide Web Consortium (W3C). These technologies include the Resource Description Framework (RDF), a variety of data interchange formats (e.g. RDF/XML, N3, Turtle, N-Triples), and notations such as RDF Schema (RDFS) and the Web Ontology Language (OWL), all of which are intended to provide a formal description of concepts, terms, and relationships of data. The function and relationship of some of these components of the Semantic Web are as follows:
XML provides an elemental syntax for content structure within documents, but does not associate semantics with the meaning of the content contained within.
XML Schema is a language for providing and restricting the structure and content of elements contained within XML documents.
RDF is a simple language for expressing data models, which refer to objects (“resources”) and their relationships. An RDF-based model can be represented in XML syntax.
RDF Schema is a vocabulary for describing properties and classes of RDF-based objects/resources, with semantics for generalized-hierarchies of such properties and classes.
OWL adds more vocabulary for describing properties and classes: among others, relations between classes (e.g. disjointness), cardinality (e.g. “exactly one”), equality, richer typing of properties, characteristics of properties (e.g. symmetry), and enumerated classes.
SPARQL (SPARQL Protocol and RDF Query Language) is a protocol and query language for semantic web data sources.
GRDDL (Gleaning Resource Descriptions from Dialects of Languages) allows users to publish data in traditional formats and specifies how these data can be translated into RDF.

Other technologies—such as microformats—with similar goals, but which are not always described as “Semantic Web,” may also be used in accordance with aspects of the present invention. A microformat is a web-based approach to semantic markup which seeks to re-use existing HTML/XHTML tags to convey metadata and other attributes in web pages and other contexts that support (X)HTML, such as RSS. Traditional markup tags used to display information on the web do not describe what the information means. Microformats bridge this gap by attaching semantics a priori, and thereby obviate other, more complicated, methods of automated processing.

The availability of machine-readable metadata enables automated agents and other software to access the Web more intelligently. The agents are able to perform tasks automatically and to locate related information on behalf of a user and/or a third party. All of these technologies and others, as known by a person having ordinary skill in the art, can be combined in order to provide descriptions that supplement or replace the content of Web documents. Thus, content may manifest itself as descriptive data stored in Web-accessible databases, or as markup within documents. The machine-readable descriptions enable content managers to add meaning to the content, e.g., to describe the structure of the knowledge regarding that content. In this way, a machine may process knowledge itself, instead of text, using processes similar to human deductive reasoning and inference, thereby obtaining more meaningful results and allowing computers to perform more robust automated information gathering and research.

In lieu of, or supplemental to, the above techniques, Web-scraping (also called Web harvesting or Web data extraction) is another method for collecting useful data about advertisement targets 16 by information extractor 20. Web-scraping is a computer software technique of extracting information from websites. Usually, such software programs simulate human exploration of the Web by either implementing low-level Hypertext Transfer Protocol (HTTP), or embedding certain full-fledged Web browsers, such as Microsoft Internet Explorer (IE) and Google Chrome. Web-scraping focuses on the transformation of unstructured Web content—typically in HTML format—into structured data that can be stored and analyzed in a central database.

Web-scraping, as opposed to the Semantic Web, favors practical solutions based on existing technologies that are often entirely ad hoc. Therefore, if utilizing Web-scrapping techniques in information extractor 20, there are different levels of automation that can be used within the scope of this invention, as will be understood by one skilled in the art:
Human copy-and-paste: sometimes this may be the only workable solution when websites explicitly setup barriers to prevent machine automated Web scraping.
Text grepping and regular expression matching: based on the UNIX grep (global/regular expression/print or Generalized Regular Expression Parser) command or regular expression matching facilities of programming languages (for instance Perl or Python).
HTTP programming: static and dynamic Web pages can be retrieved by posting HTTP requests to the remote Web server using socket programming.
DOM (Document Object Model) parsing: by embedding a Web browser, such as Microsoft Internet Explorer or Google Chrome, programs can retrieve the dynamic contents generated by client-side scripts. These Web browser controls also parse Web pages into a DOM tree, based on which programs can retrieve parts of the Web pages.
HTML parsers: some data query languages, such as the XML query language (XQL) and the hyper-text query language (HTQL), can be used to parse HTML pages and to retrieve and transform Web content.
Web-scraping software: there are many Web-scraping software tools available that can be used to customize Web-scraping solutions. These tools may provide a Web recording interface that removes the necessity to manually write Web-scraping code, some scripting functions that can be used to extract and transform Web content, and/or database interfaces that can store the scraped data in local databases.
Vertical aggregation platforms: these platforms create and monitor a multitude of “bots” for specific verticals with no man-in-the-loop, and no work related to a specific target site. Once the knowledgebase for the entire vertical is established, the platform creates the bots automatically.
Semantic annotation recognizing: Web pages may embrace metadata or semantic markups/annotations which can be made use of to locate specific data snippets. The annotations may be embedded in the pages as microformats or organized into a semantic layer stored and managed separately from the Web pages. In the latter case, Web scrapers can retrieve data schema and instructions from this layer before scraping the pages.

Upon reading this disclosure, a person having ordinary skill in the art will readily appreciate that such information extraction technologies may be utilized by information extractor 20 to gather information about advertisement targets 16 to help more precisely select advertisements that will have appeal to a majority of individuals present in a crowd. Such advertisements thereby will likely have greater impact on a group of advertisement targets than conventional advertisement selection processes. Information extractor 20 can be integral to a larger advertisement system or can be a separate entity. For example, information extractor 20 may be integrated into other components such as data miner 22, information aggregator 24, advertisement processor 12, and/or advertisement consumer 14. Information extractor 20 can be, for example, a commercial service contracted to perform some or all of these functions discussed above.

At block 116, target information as defined above in relation to block 114 is obtained from shared sensor data from mobile radio terminal 30. This sensor data originates from one or more mobile radio terminals 30 within proximity of a network sensor. The information may be obtained directly from the one or mobile radio terminals 30 through a connection with wireless access point 58 or it may be obtained indirectly through network 18 by information extractor 20, for example. It should be noted that other methods of obtaining this shared sensor data will be apparent to a person of ordinary skill in the art and are deemed to fall within the scope of the present invention. Obtaining the target information may occur as part of any one or more of the information extractor 20, the data miner 22, the information integrator 24 and/or the advertisement processor 12. A person of ordinary skill in the art will recognize that such functionality also may take place in a separate component not shown.

Some examples of types of data provided through the mobile radio terminal 30 and their potential uses are as follows:

Temperature sensor 36 may provide ambient temperature that could be used, for instance, to indicate a cold day where an advertisement featuring hot chocolate or coffee would be well received.

Medical sensor(s) 38—such as a heart rate monitor, temperature probe, blood oxygenation monitor, blood pressure monitor, skin conductivity sensor, and/or chemical sensors, for example—may provide data indicating present stress levels, health, and hunger of an individual which could help determine an appropriate advertisement, as well as to gauge reaction to an advertisement.

Camera 40 may show nearby objects or other people, or may show the face of the individual user of the mobile radio terminal 30. Face detection and computer vision techniques for determining facial expressions may provide a method of gauging the mood of advertisements targets 16, and facial recognition may be used to identify individuals in the crowd.

Microphone 42 may provide data regarding the ambient noise level or the mood of the crowd. An advertisement could then be selected to match the noise level or the mood of the crowd. Also, voice and speech recognition techniques may be used to identify speakers or subjects of conversation, respectively.

Pedometer 46 may, for instance, provide data about the amount of walking an individual has done already in a day (perhaps indicating an ad for foot care products, energy bars, etc. is appropriate) or the speed of walking (perhaps indicating a shorter advertisement is appropriate).

At block 118, target information is obtained from sensors associated with advertisement consumer 14. Such target information as defined above in reference to block 114 may include, for example, products in the possession of a target, the facial expressions of a target, speed a target is walking, etc. The sensors associated with advertisement consumer 14 may provide information, for example, similar to the camera 40 and microphone 42 of mobile radio terminal 30 to the advertisement consumer 14.

For the sake of illustration, it may be understood that the target information is obtained as part of the functionality of advertisement consumer 14. A person having ordinary skill in the art will readily appreciate that obtaining target information may take place by one or more other components of the system 5.

The target information received by blocks 114, 116, and 118 is interpreted at block 120. For the sake of illustration, it may be understood that data interpretation may be a function of the data miner 22. A person having ordinary skill in the art will readily appreciate that the interpreting function may take place by one or more other components.

Once process 110 has obtained useful information about targets, data mining techniques can be used to make logical inferences about the now-understandable data.

Clustering methods known to those skilled in the art may be used to discover groups and structures in the data that are in some way or another “similar”, without using previously-known structures in the data.

Classification methods known to those in the art may be used to generalize known structure to apply to new data. For example, a classification algorithm might attempt to classify a musical group mentioned in data obtained from network 18 as one that is liked or disliked by an advertisement target 16. Common classification techniques that can be used include—but are not limited to—maximum entropy classifiers, Naive Bayes classifiers, support vector machines (SVMs), decision trees, perceptrons, neural networks (multi-layer perceptrons), k-nearest neighbor classifiers, and radial basis function classifiers.

Regression methods known to those skilled in the art can be used to attempt to find a function which models the data with the least error. By way of illustration and not limitation, one or more consumer profiles may be found to match an advertisement target 16 or group of advertisement targets 16 with the least error.

Association rule learning methods known to those skilled in the art can be used to search for relationships between variables. For example, information regarding one or more advertisement targets' 16 purchasing habits may be known. Using association rule learning, an algorithm may determine which products are frequently bought together or which products are bought during which part of the week or year.

Data miner 22 may also be configured to determine a target profile or to determine specific product recommendations for a target as detailed below in regards to block 122 performed by information integrator 24.

The data miner 22 can be integral to a larger advertisement system or can be a separate entity. For example, data miner 22 may be integrated into other components such as information extractor 20, information aggregator 24, advertisement processor 12, and/or advertisement consumer 14. The data miner 22 can be, for example, a commercial service contracted to perform some or all of these function discussed above (e.g. Hunch, Sugestio, and easyrec provide services similar to those that may be performed by data miner 22).

The process 110 integrates target information of advertisement target 16 into more useful interest information at block 122, as described herein. For the sake of illustration, it may be understood that stage 122 takes place as part of information integrator 24. A person having ordinary skill in the art will recognize that the integration function may take place as part of one or more other components.

In a one embodiment, information integrator 24 is configured to receive information from the data miner 22 from sensors associated with advertisement consumer 14 and sensors associated with mobile radio terminal 30. This information may be processed data, and all levels of processing are within the scope of the invention. The data may, for instance, be basic data about purchase history, interests, dislikes, etc. The data may also, for instance, be a more completed profile of a target, or series of recommendations of specific products for a target. The information integrator 24 processes this information to form interest information for an advertisement target 16.

The information integrator 24 may use a recommender system adapted from those known in the art A recommender system compares a user profile to some reference characteristics and seeks to predict the ‘rating’ that a user would give to a consumer item they had not yet considered. These characteristics may be from the consumer item (the content-based approach) or the user's social environment (the collaborative filtering approach).

One commonly used algorithm in recommender systems that is suitable for use in the present invention is the k-nearest neighborhood approach. In a social network, a particular user's neighborhood with similar taste or interest can be found by calculating Pearson Correlation. By collecting the preference data of the top-k nearest neighbors of the particular user (weighted by similarity), the user's preference can be predicted by calculating the data using certain techniques known in the art.

Another family of algorithms that is widely used in recommender systems and is also within the scope of the present invention is collaborative filtering. One of the most common types of collaborative filtering is item-to-item collaborative filtering (people who buy x also buy y), an algorithm popularized by Amazon.com's recommender system.

Alternative methods can be used by the information integrator 24 and are within the scope of this invention. For example, and not by way of limitation, the information integrator 24 may be configured to aggregate data from data miner 22 and use recommender schemes for the group of advertisement targets 16. Further, information integrator may be configured to produce a profile of individual users. This profile may be a simplified or representative data structure that concisely identifies aspects of an individual such as interests, product purchases, wealth, mood, for example. Still further, because predictive accuracy is known to substantially improve when blending multiple predictors, a combination of methods may be used by information integrator 24.

The information integrator 24 may be integral to a larger advertisement system or may be a separate entity. For example, information integrator 24 may be integrated into other components such as information extractor 20, data miner 22, advertisement processor 12, and/or advertisement consumer 14. The information integrator 24 may be, for example, a commercial service contracted to perform some or all of these function discussed above. In one embodiment, the interest information generated by information integrator 24 is then passed on to advertisement processor 12 to use in selecting an advertisement.

FIG. 6 is a flow diagram of an exemplary process 130 for selecting an advertisement relevant to a group of advertisement targets 16 in accordance with aspects of the present invention. For the sake of illustration, it may be understood that the process described herein takes place as part of the advertisement processor 12. A person having ordinary skill in the art will appreciate that the function for selecting an advertisement may occur in or more other components.

At block 132, interest information related to advertisement targets 16 is received. Interest information is generated at block 122 by interest integrator 24, for example. Interest information is described above in relation to block 122, and is the distilled or refined target information, detailed above, that is useful to the advertisement processor 12—for example, in determining which advertisement(s) would better appeal to an individual.

At block 134, interest information is aggregated to determine aggregate interest information. For the sake of illustration, it may be understood that the functionality of block 134 may take place as part of target interest aggregator 98. The aggregation of interest information may occur by any method known to those skilled in the art and those methods described above in relation to the target interest aggregator 98 of advertisement processor 12 are applicable to provide the desired functionality.

At block 136, the impact of advertisements on advertisement targets 16 is predicted as described herein, in relation to impact assessor 94. For the sake of illustration, it may be understood that the functionality of block 136 may take place as part of impact assessor 94 and/or one or more other components of the system.

Impact assessor 94 may access advertisements stored in database(s) 82 and/or information regarding advertisements stored in database(s) 82 such as keywords and other information collected or generated by advertisement entry and characterization component 80. Impact assessor 94 compares this information to the aggregate interest information provided by block 134 to select advertisements that will have appeal to a majority of the individuals that compose a crowd (e.g., select an advertisement that will generate an impact on the group of advertisement targets 16). This comparison may be any method known to one having ordinary skill in the art that predicts which advertisement would be effective or relevant to an audience. For example, criteria may be provided by an advertiser for a preferred advertisement target 16 group that indicates likes and dislikes, the preferred mood (excited, subdued, etc.), and any other characteristics of the group deemed to be important. As well as relating to the interests of advertisement targets 16 (as in a heavily modified recommender system), advertisements may also be assessed based on the type of advertisements that the advertisement targets 16 are receptive to (e.g. emotionally appealing, rationally appealing, celebrity sponsored, expert endorsed, flashy, subdued, etc.).

At block 138, one or more advertisements are selected. As stated above, the advertisements are selected to appeal to a majority of individuals in a crowd, thereby maximizing the impact on advertisement targets 15. For the sake of illustration, it may be understood that stage 138 occurs as part of the advertisement selection component 92. One skilled in the art will readily appreciate that the selection of advertisement(s) may occur in one or more other components of the system.

The advertisement selection component 92 selects an advertisement from database(s) 82. The advertisement is selected to appeal to a majority of individuals in a crowd to maximize an expected impact on the group of advertisement targets 16. Any method known to those skilled in the art may be used to select the advertisement. The advertisement is also selected to be of the appropriate medium for the advertisement consumer 14. The advertisement may be a commercial advertisement for a product or service, a political advertisement, a non-commercial mood-altering display, or some other type of sensory message (e.g., educational or instructional messages, public service announcements, health advisories, traffic warning messages, train/airplane cancellation messages, governmental campaigns for exercising or eating healthy foods, and so on). One of ordinary skill in the art will readily appreciate that any type of message that may be of interest to one or more individuals of a crowd is deemed to be within the scope of the present invention.

The advertisement selection component 92 may also be configured to generate an original advertisement that appeals to one or more members of the group of advertisement targets 16. This generated advertisement may be assembled from images, audios data, text, etc. stored in database(s) 82 or accessed from the network 18. Alternatively, the advertisement may be generated using computer techniques known in the art, without using stored or accessed components. Further, a combination of techniques may be used to create and/or to compile this newly generated advertisement. Such an advertisement may be stored in database(s) 82 for further use, and may be assessed for impact on advertisement targets 16 as previously discussed.

The advertisement selection component 92 may consider, for example, the combination and order of advertisements presented when determining maximum impact. For example, similar advertisements might begin to annoy advertisement targets 16. Further, elements of advertisements might enhance the impact of subsequent advertisements. For example, an advertisement for a kitchen mixer that contains images of mixing dough (or even expelled scents made to imitate the smell of baking cookies) might enhance a subsequent advertisement for a nearby bakery or grocery store by making advertisement targets 16 feel hungry.

At block 140, at least one advertisement is output in a user-sensible form to the advertisement consumer 14. For the sake of illustration, it may be understood that stage 140 takes place as part of advertisement serving component 96 and ad consumer interface 90, although a person having ordinary skill in the art will readily appreciate outputting the at least one advertisement may occur in one or more other components of the system. Advertisement serving component 96 formats the selected advertisement(s) to be compatible with the features and formats of advertisement consumer 14. Advertisement consumer interface 90 outputs the chosen advertisement(s) to advertisement consumer 14 in a form that is generally compatible with the rendering device that the advertisement targets may perceive the advertisement.

At block 142, the advertiser 10 may be billed for selecting an advertisement associated with advertiser 10. The bill may be based on several factors including, but not limited to, location of the advertisement consumer 14, number of advertisement targets 16 interested in the advertisement, number of advertisement targets within sensory range of the advertisement consumer 14, expected impact, conversion rate, time of day, and length of advertisement, as is conventional.

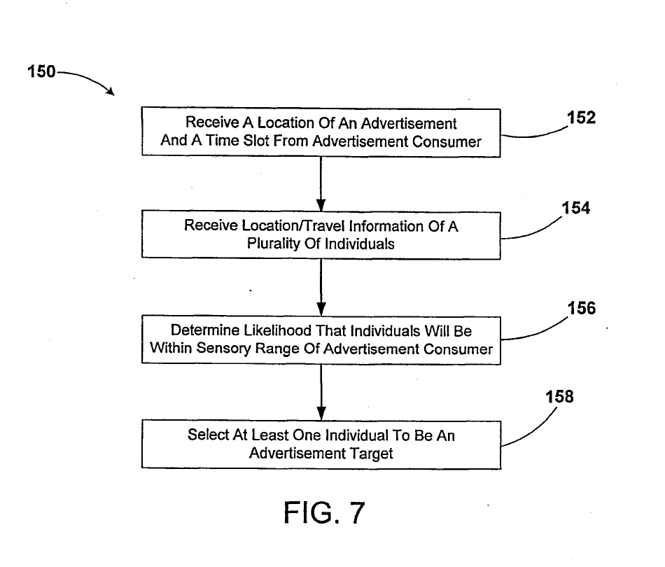

Referring to FIG. 7, a flow diagram of an exemplary process 150 for identifying a group of advertisement targets 16 is illustrated. For the sake of illustration, it may be understood that the process described herein takes place as part of the advertisement processor 12, although a person having ordinary skill in the art will recognize that such functionality may take place in one or more other components of the system.

At block 152, location information and time information relating to an advertisement consumer 14 is received at the advertisement processor 12. The location and time information will preferably be accompanied by or preceded by a request for at least one advertisement. The location information will preferably include the geographical location of the advertisement consumer 14. Alternatively, the geographical information may be already stored in a database 82 and may be retrieved by stage 152 upon receipt of corresponding identification of an advertisement consumer. Additionally, time information may include an approximate or exact time at which the requested advertisement should be played. Time information may also include a duration or an end time for the advertisement.

At block 154, location information and/or travel information associated with a plurality of individual persons is received. The plurality of individuals may be all of the persons with a digital footprint or may be a subset of individuals. The subset of individuals may be chosen by any method known in the art. For example and without limitation, if the advertisement consumer 14 is a television content provider, the subset of individuals may be the social network (“friends”) of the residents of the home in which the television is located. As another example, if the advertisement consumer 14 is a digital billboard display, the subset of individuals may be those who are accessing cellular towers in the area, or whose car-based GPS system has located them in the area.

Location information may be information used to determine the present location of an individual. Travel information may be information used to determine the future locations and travel routes of an individual. Location information and travel information may be obtained by analyzing the digital footprints of individuals, by communicating with an individual's mobile radio terminal 30, or deriving the location of a mobile radio terminal 30 by querying the communications network provider the mobile radio terminal 30 is connected to.

At block 156, the probability that individual persons will be within sensory range of the advertisement consumer that sent the advertisement request is determined as detailed herein.

Target locator 108 uses the information received in stage 154 to estimate the geographical location of an individual. GPS location information is strongly reliable information and can result in a “verified” location. However, other information derived from social networking or cell towers or wireless access points can also serve as a foundation for location information and can provide a probability of location. For instance, a tweet or status update mentioning that the person is now at a certain location or looking at a certain object or building can provide location information. As another example, image data from a camera on a smart phone (e.g., using Google Goggles) can provide location information using landmark recognition techniques known to those skilled in the art. As yet another example, calendar and scheduling information may reveal much about an individual's present and future locations. As still a further example, a camera associated with an advertisement consumer 14 can provide images that, using facial recognition techniques, are used to uniquely identify individuals currently at the advertisement consumer 14.

Static location information can be utilized, or dynamic information can be utilized. As a non-limiting example of the latter, a group of football fans on a subway heading to the game can be predicted to pass a digital display (advertisement consumer 14) in the subway station after disembarking from the train at the station closest to the stadium along their route.

At block 158, at least one individual from a plurality of individuals is selected to be an advertisement target.

The target selector 109 may select advertisement targets 16 by using a threshold value. For instance, all of the individuals may be given a probability of being within sensory range of the advertisement consumer 14. Those with a probability greater than a certain threshold (say, e.g. 95%) will be chosen as advertisement targets 16. Any appropriate threshold may be used as will be understood by those skilled in the art. The threshold value may change based on the location, the media of the advertisement, the time of day, the number of targets, etc.

Those skilled in the art will understand that process 150 may be carried out either before or after the request for an advertisement occurs. For example, and as distinct from the examples given above, process 150 may be carried out to track individuals on a substantially continuous basis so that location information is easier and quicker to access at the appropriate time. Further, tracking someone over time can improve the quality and precision of location determinations because individuals develop patterns, can only move so quickly, and may provide more clues to location over time. Furthermore, while one or more stages have been described as occurring in a particular component of the system, such functionality may occur in one or more other different components of the system.

Although the illustrated methods illustrate a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of providing messages comprising:
receiving information related to advertisement targets (16),
processing the information related to advertisement targets to determine aggregate interest information, wherein the aggregate interest information corresponds to one or more interests of the advertisement targets;
selecting at least one message of a plurality of messages based on the aggregate interest information, and
outputting the at least one selected message to an advertisement consumer (14) for rendering by one or more of the advertisement targets.

2. The method of claim 1, wherein the advertisement targets are determined to be within range of the advertisement consumer.

3. The method according to claim 1, further including collecting reaction information related to at least one advertisement target from a sensor in communication with a mobile radio terminal.

4. The method according to claim 1, wherein the step of outputting at least one selected message includes selecting a message from a database of messages (82) provided by at least one advertiser (10).

5. The method of claim 4, further including billing at least one advertiser that corresponds to the selected message, based on a number of advertisement targets interested in the message, a number of advertisement targets within sensory range of the message, a location of the advertisement consumer, a reaction of at least one advertisement target, and/or or a time of day in which the selected message is output.

6. The method according to claim 1, wherein the step of selecting the at least one message comprises generating a new message based on the aggregate interest information.

7. The method according to claim 1, wherein the at least one message includes a non-commercial mood-altering display.

8. The method according to claim 1, wherein at least some of the information related to advertisement targets is obtained from social-networking data.

9. The method according to claim 1, wherein at least some of the information related to advertisement targets is obtained from a sensor (36, 38, 30, 42, 44, 46, 48) in communication with a mobile radio terminal.

10. An advertisement consumer system comprising:
at least one dynamic media device (14),
a communications device connected to an advertisement processor (12), wherein
the communications device (68) is configured to receive messages from the advertisement processor,
the at least one dynamic media device is configured to present the messages, and
the messages are selected based on aggregate interest information of advertisement targets within sensory range of the dynamic media device.

11. The advertisement consumer system of claim 10, further comprising sensors configured to provide information to an advertisement processor.

12. The advertisement consumer system according to claim 10, wherein the at least one dynamic media device comprises a speaker.

13. The advertisement consumer system according to claim 10, wherein the at least one dynamic media device comprises an electronic billboard.

14. The advertisement consumer system according to claim 10, wherein the at least one dynamic media device comprises a general purpose computer and monitor.

15. The advertisement consumer system according to claim 10, wherein the at least one dynamic media device comprises a television.

16. The advertisement consumer system according to claim 10, wherein the aggregate interest information is at least partly derived from social-networking data.

17. The advertisement consumer system according to claim 10, wherein the aggregate interest information is at least partly derived from sensor data.

18. A method of identifying advertisement targets (16) comprising,
receiving a location of an advertisement consumer (14) having one or more network sensors;
receiving at least one of location information or travel information of a plurality of individuals,
determining respective likelihoods of the plurality of individuals being within a range of the one or more network sensors of the advertisement consumer at a time, and
selecting at least one individual from the plurality of individuals to be one of the advertisement targets.

19. The method of claim 18, further including deriving the location information and travel information from at least one of Global Positioning System information, cellular tower connection information, wireless access point connection information, or social-networking information.

20. The method according to claim 18, further including processing network sensor information to determine a reaction from at least one of the plurality of individuals to a message appearing on the advertisement consumer.
